(19) United States
(12) Patent Application Publication
(10) Pub. No.: US 2009/0156443 A1
(43) Pub. Date: Jun. 18, 2009

(54) ORGANIC MOLYBDENUM ADDITIVE, ITS PREPARATION METHOD, A LUBRICATING COMPOSITION CONTAINING SAID ADDITIVE, AND USE OF THE SAME

(75) Inventors: Wei Xu, Beijing (CN); Kecheng Wei, Beijing (CN); Qinghua Duan, Beijing (CN); Fuhui Zhang, Beijing (CN)

Correspondence Address: SCULLY SCOTT MURPHY & PRESSER, PC, 400 GARDEN CITY PLAZA, SUITE 300, GARDEN CITY, NY, 11530, US

(73) Assignees: CHINA PETROLEUM & CHEMICAL CORPORATION, Beijing (CN); RESEARCH INSTITUTE OF PETROLEUM PROCESSING SINOPEC, BEIJING (CN)

(21) Appl. No.: 12/281,120

(22) PCT Filed: Feb. 28, 2007
(86) PCT No.: PCT/CN2007/000638

§ 371 Date: Dec. 2, 2008

(30) Foreign Application Priority Data
Feb. 28, 2006 (CN) 200610008072.6

(51) Int. Cl. C10M 133/38; C07F 11/00; C10M 139/06; C10M 133/44

(52) U.S. Cl. 508/272; 556/57; 508/367; 508/280

(57) ABSTRACT

The present invention relates to an organic molybdenum additive and its preparation method, and a lubricating composition comprising said additive, and use of said additive and its lubricating composition in the aspect of improving antiwear and antifriction property of oil products. The organic molybdenum additive according to the present invention is characterized in that it is prepared by reacting several kinds of feedstock as follows: a polylol ester of p-hydroxybenzene alkyl acid, an inorganic molybdenum compound and an aliphatic amine and/or an aromatic amine and/or an amide. The organic molybdenum additive of the present invention has excellent antiwear and/or antifriction property.

### TECHNICAL FIELD

The present invention relates to an organic molybdenum additive and the preparation method thereof, a lubricating composition containing said additive, and use of said additive or said lubricating composition containing said additive in the aspect of improving properties of antiwear and antifriction

### BACKGROUND ART

Along with environmental protection laws being increasingly rigorous and requirement of saving energy being higher and higher, engine manufacturers make continuously engine size reduced, compression ratio increased and motor operation temperature elevated, and thus fuel utilization improved, energy resource saved and waste gas emission reduced. In the meanwhile, the lubricant oil is also required to have better properties of antiwear and antifriction. These all propose higher requirement of lubricants in properties of antiwear, antifriction and antioxidant.

Phosphor contained in lubricant oil may shorten effective life of the catalyst in tail-gas converter of automobile, and sulfur contained in the lubricant oil is incompatible with an elastomer sealing element and corrosive. Therefore, an organic molybdenum additive having no sulfur and no phosphor can be applied to lubricant oils with high grade and high standard and has more broad applicability.

U.S. Pat. No. 4,692,256 discloses an organic molybdenum lubricant additive having properties of antiwear, antifriction and antioxidation.

U.S. Pat. No. 4,889,647 discloses an organic molybdenum lubricant additive prepared by reacting a fatty oil and diethanolamine with an inorganic molybdenum compound, said additive has properties of antiwear and antifriction, and is commercially avaiablein a name of model No.855 by VANDERBILT.

U.S. Pat. No. 5,137,647 discloses an organic molybdenum lubricant additive prepared by reacting a fatty oil or acid and 2-(2-amino ethyl) aminoethanol with an inorganic molybdenum compound, said additive has properties of antiwear, antifriction and antioxidation and the like.

U.S. Pat. No. 5,412,130 discloses a process for preparing an organic molybdenum lubricant additive by reacting a diol, a diamine, a thiol and an aminoethanol with an inorganic molybdenum compound.

U.S. Pat. No. 6,046,263 discloses a multifunction lubricant additive having combined properties of antiwear, antifriction and antioxidation, commercially available in a name of model No. F10A by CIBA Corp.

However, in the prior art, some no-sulfur and no-phosphor lubricant additive products are superior in antiwear property, but inferior in antifriction property ; or superior in antifriction property, but inferior in antiwear property ; Or some may mainly take effect under condition of mixed lubrication, and some may take effect under condition of boundary lubrication. Therefore to develop a lubricant additive with even better properties of antiwear and antifriction still is an exertive direction for one skilled in the art.

### CONTENTS OF THE INVENTION

One object of the present invention is to provide an organic molybdenum additive different from that in the prior art with better properties of antiwear and antifriction, said organic molybdenum additive is prepared by reacting three kinds of materials as follows:
a. A polylol ester of p-hydroxybenzene alkyl acid
b. An inorganic molybdenum compound; and
c. An aliphatic amine, an aromatic amine, an amide or the mixture thereof.

Said polylol ester of p-hydroxybenzene alkyl acid refers to a polylol ester of p-hydroxybenzene alkyl acid having shielded phenol antioxidant group.

Another object of the present invention is to provide a preparation method of aforementioned organic molybdenum additive, comprising reacting aforementioned reactants a, b and c.

Another further object of the present invention is to provide a lubricant composition containing aforementioned organic molybdenum additive together with further lubrication base oil.

Again additional object of the present invention is to provide the use of aforementioned organic molybdenum additive and the lubricating composition containing said additive in engine lubricating oil, gear oil, hydraulic oil or oils for metal working, and grease, in particular the use in said oil products and greases for improving property of antiwear and/or antifriction.

### DESCRIPTION OF FIGURES

FIG. 1: An infrared spectrum of the organic molybdenum additive M-02 prepared in Example I of the present invention is shown. FIG. 2: An infrared spectrum of the organic molybdenum additive M-05 prepared in Example 4 of the present invention is shown. FIG. 3: An infrared spectrum of the organic molybdenum additive M-07 prepared in Example 6 of the present invention is shown.

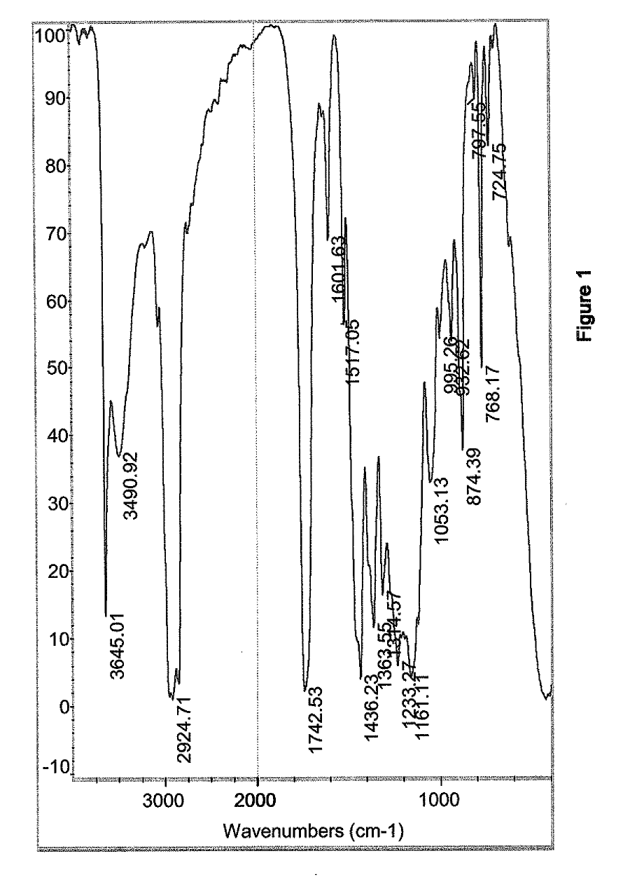

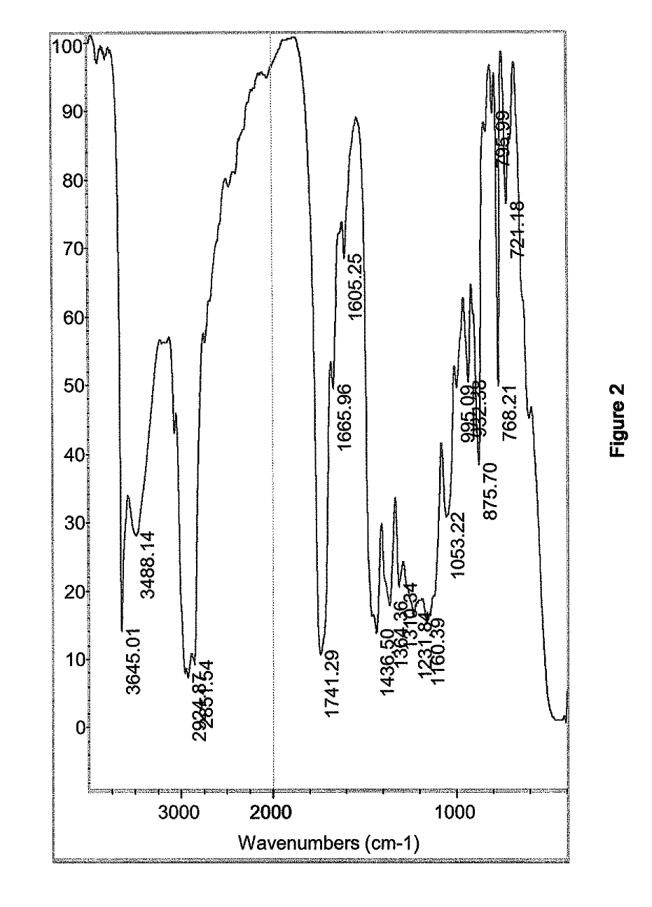

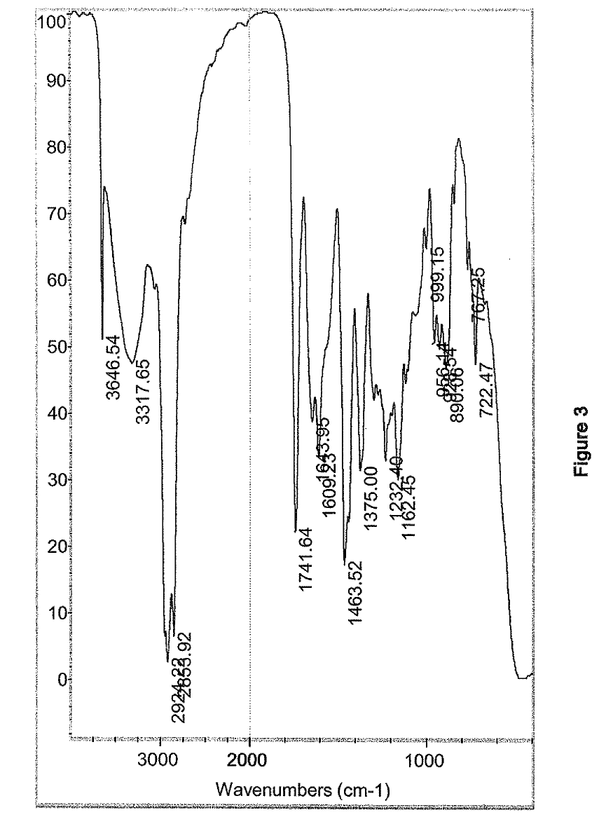

### MODE OF CARRYING OUT THE INVENTION

The singular forms “a”, “an”, and “the” include plural referents unless the context clearly dictates otherwise.

The organic molybdenum additive of the present invention is prepared by reacting the three kinds of materials as follows:
a. A polylol ester of p-hydroxybenzene alkyl acid;
b. An inorganic molybdenum compound; and
c. An aliphatic amine, an aromatic amine, an amide or the mixture thereof.

Said polylol ester of p-hydroxybenzene alkyl acid refers to a polylol ester of p-hydroxybenzene alkyl acid having shielded phenol antioxidant group, wherein the carbon atom number of tile polylol is between 2-12 and the hydroxyl number is between 2-5. Said polylol ester of p-hydroxybenzene alkyl acid has preferably a general formula as follows:

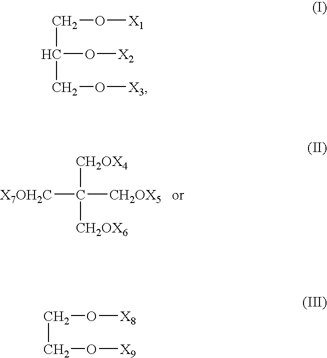

Wherein at least one of X₁, X₂ and X₃ is a group represented by structural formula (a), at least one of X₄, X₅, X₆ and X₇ is a group represented by structural formula (a), at least one of X₈ and X₉ is a group represented by structural formula (a), the remaining groups may be die same or different, and may be independently selected from H atom, group represented by structural formula (a) and group represented by structural formula (b),

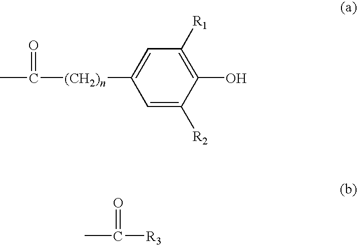

Wherein R₁ and R₂ may be the same or different, and independently selected from alkyl having a carbon atom number between 1˜4, preferably tert-butyl; n is an integer number of 2˜12, preferably 2˜8, most preferably 2, 3 or 4; R₃ is 11 atom or a saturated or unsaturated hydrocarbyl group having a carbon atom number between 1˜30, preferably 5˜20, and most preferably 10˜18.

Preferred material with aforementioned general formula (I), (II) and (III) is one selected from the group consisting of: mono glyceride compound of 3,5-di-tert-butyl p-hydroxybenzene propionic acid (a compound of structural formula I, wherein, one of groups X₁, X₇ and X₃ is selected from the group represented by structural formula (a) in which n is 2 and both R₁ and R₂ are tert-butyl, and each of the remaining groups in X₁, X₂ and X₃ is independently selected from H), diglyceride of 3,5-di-tert-butyl p-hydroxybenzene propionic acid (a compound of structural formula 1, wherein, two of croups X₁, X₂ and X₃ are selected from the group represented by structural formula (a) in which n is 2 and are R₁ and R₂ are tert-butyl, and the remaining group in X₁, X₇ and X₃ is selected from H), triglyceride of 3,5-di-tert-butyl p-hydroxybenzene propionic acid (a compound of structural formula I, wherein X₁, X₂ and X₃ are all selected from group represented by structural formula (a) in which n is 2 and both R₁ and R₂ are tert-butyl), mono pentaerythritol ester of 3,5-di-tert-butyl p-hydroxybenzene propionic acid (a compound of structural formula II, wherein, one of groups X₄, X₅, X₆ and X₇ is selected from the group represented by structural formula (a) in which n is 2 and both R₁ and R₂ are tert-butyl, and the remaining groups in X₄, X₅, X₆ and X₇ are selected from H), pentaerythritol diester of 3,5-di-tert-butyl p-hydroxybenzene propionic acid (a compound of structural formula II, wherein, two of groups X₄, X₅, X₆ and X₇ are selected from the group represented by structural formula (a) in which n is 2 and both RI and R, are tert-butyl, and the remaining groups in X₄, X₅, X₆ and X₇ are selected from H), pentaeryhritol triester of 3,5-di-tert-butyl p-hydroxybenzene propionic acid (a compound of structural formula (II), wherein, three of groups X₄, X₅, X₆ and X₇ are selected from the group represented by structural formula (a) in which n is 2 and both R₁ and R₂ are tert-butyl, and the remained group in X₄, X₅, X₆ and X₇ is selected from H), pentaerythritol tetraester of 3,5-di-tert-butyl p-hydroxybenzene propionic acid (a compound of structural formula II, wherein all groups of X₄, X₅, X₆ and X₇ are the group represented by structural formula (a) in which n is 2 and both R₁ and R₂ are tert-butyl), monoethyleneglycol ester of 3,5-di-tert-butyl p-hydroxybenzene propionic acid (a compound of structural formula III, wherein one of groups X₈ and X₉ is selected from the group represented by structural formula (a) in which n is 2 and both R₁ and R₂ are tert-butyl, and the remained group in X₈ and X₉ is selected from H), ethylene glycol diester of 3,5-di-tert-butyl p-hydroxybenzene propionic acid (a compound of structural formula III, wherein both X₈ and X₉ are the group represented by structural formula (a) in which n is 2 and both R₁ and R₂ are tert-butyl), diglyceride of 3,5-di-tert-butyl p-hydroxybenzene propionic acid and oleic acid (a compound of structural formula I, wherein one of groups X₁, X₂ and X₃ is selected from the group represented by structural formula (a) in which n is 2 and both R₁ and R₂ are tert-butyl, another group in X₁, X₂ and X₃ is selected from oleoyl group represented by structural formula (b)), diglyceride of 3,5-di-tert-butyl p-hydroxybenzene propionic acid and stearic acid, diglyceride of 3,5-di-tert-butyl p-hydroxybenzene propionic acid and lauric acid, diglyceride of 3,5-di-tert-butyl p-hydroxybenzene propionic acid and myristic acid, diglyceride of lauric acid, diglyceride of 3,5-di-tert-butyl p-hydroxybenzene propionic acid and palmitic acid, triglyceride of 3,5-di-tert-butyl p-hydroxybenzene propionic acid and oleic acid and stearic acid (a compound of structural formula I, wherein, X₁, X₂ and X₃ are respectively selected from the group of structural formula (a) in which n is 2 and both R₁ and R₂ are tert-butyl, oleoyl group of structural formula (b) and stearyl group of structural formula (b)), triglyceride of 3,5-di-tert-butyl p-hydroxybenzene propionic acid and distearic acids (a compound of structural formula I, wherein one of groups X₁, X₂ and X₃ is selected from the group of structural formula (a) in which n is 2 and both R₁ and R₂ are tert-butyl, and the other two groups in X₁, X₂ and X₃ are selected from stearyl group of structural formula (b)), triglyceride of 3,5-di-tert-butyl p-hydroxybenzene propionic acid and dilauric acids, triglyceride of 3,5-di-tert-butyl p-hydroxybenzene propionic acid and dipalmitic acids, triglyceride of 3,5-di-tert-butyl p-hydroxybenzene propionic acid, lauric acid and stearic acid (a compound of structural formula 1, wherein X₁, X₂ and X₃ are selected respectively from the group of structural formula (a) in which n is 2 and both R₁ and R₂ are tert-butyl, lauroyl group of structural formula (b) and stearyl group of structural formula (b)), triglyceride of 3,5-di-tert-butyl p-hydroxybenzene propionic acid, palmitic acid and stearic acid, triglyceride of 3,5-di-tert-butyl p-hydroxybenzene propionic acid, myristic acid and stearic acid, pentaerythritol diester of 3,5-di-tert-butyl p-hydroxybenzene propionic acid and oleic acid (a compound of structural formula II, wherein, two of groups X₄, X₅, X₆ and X₇ are selected respectively from the group of structural formula (a) in which n is 2 and both R₁ and R₂ are tert-butyl, and oleoyl group of structural formula (b), an-d the other two of groups X₁, X₅, X₆ and X₇ are selected from H), pentaerythritol diester of 3,5-di-tert-butyl p-hydroxybenzene propionic acid and stearic acid, pentaerythritol diester of 3,5-di-tert-butyl p-hydroxybenzene propionic acid and lauric acid, pentaerythritol diester of 3,5-di-tert-butyl p-hydroxybenzene propionic acid and myristic acid, pentaerythritol diester of 3,5-di-tert-butyl p-hydroxybenzene propionic acid and palmitic acid, pentaerythritol triester of 3,5-di-tert-butyl p-hydroxybenzene propionic acid, lauric acid and stearic acid (a compound of structural formula II, wherein three of groups X₄, X₅, X₆ and X₇ are respectively selected from the group of structural formula (a) in which n is 2 and both R₁ and R₂ are tert-butyl group, lauroyl group of structural formula (b) and stearyl group of structural formula (b), and another group in X₄, X₅, X₆ and X₇ is selected from H) , pentaerythritol triester of 3,5-di-tert-butyl p-hydroxybenzene propionic acid, oleic acid and stearic acid, pentaerythritol triester of 3,5-di-tert-butyl p-hydroxybenzene propionic acid, palmitic acid and stearic acid, pentaerythritol triester of 3,5-di-tert-butyl p-hydroxybenzene propionic acid and distearic acids (a compound of structural formula II, wherein one of groups X₄, X₅, X₆ and X₇ is selected from the group of structural formula (a) in which n is 2 and both R₁ and R₂ are tert-butyl group, other two groups in X₄, X₅, X₆ and X₇ are selected from stearyl group of structural formula (b), and another one of groups X₄, X₅, X₆ and X₇ is selected from H), pentaerythritol tetraester of 3,5-di-tert-butyl p-hydroxybenzene propionic acids, oleic acid and distearic acids (a compound of structural formula II, wherein one of groups X₄, X₅, X₆ and X₇ is selected from the group of structural formula (a) in which n is 2 and both R₁ and R₂ are tert-butyl, other two groups in X₄, X₅, X₆ and X₇ are selected from stearyl group of structural formula (b), and another group in X₄, X₅, X₆ and X₇ is oleoyl group of structural formula (b)), ethyleneglycol ester of 3,5-di-tert-butyl p-hydroxybenzene propionic acid and stearic acid (a compound of structural formula III, wherein one of groups X₈ and X₉ is selected from the group of structural formula (a) in which n is 2 and both R₁ and R₂ are the tert-butyl group and the other group in X₈ and X₉ is selected from stearyl group of structural formula (b), and the mixture thereof.

Said inorganic molybdenum compound is one selected from the group consisting of ammonium molybdate, ammonium paramolybdate, sodium molybdate, molybdenum trioxide and the mixture thereof.

Said aliphatic amine is one selected from the group consisting of primary; secondary, tertiary amine or alkylene diamine having a carbon atom number of 4˜30, an amino number between 1˜5 and the mixture thereof. Preferred aliphatic amine is one selected from the group consisting of primary, secondary, tertiary aliphatic amine having a carbon atom number of 4˜25 and an amino number between 1˜4 and mono alkylated alkylene diamine derived from a fatty acid having a carbon atom number of 12˜18, and the mixture thereof The most preferred aliphatic amine is one selected from the group consisting of butylamine, hexylamine, octylamine, laurylamine, hexadecylamine, octadecyamine, dibutylamine, diamylamine, dihexylamine, dodecyl ethylene diamine, dodecyl trimethylene diamine, cetyl ethylene diamine, cetyl trimethylene diamine, octadecyl ethylene diamine, octadecyl trimethylene diamine, coco trimethylene diamine, tallow trimethylene diamine, oleyl trimethylene diamine, N,N-dimethyl lauryl amine, N,N-dimethyl cetylamine, N,N-dimethyl stearyl amine, and the mixture thereof.

Said aromatic amine is one selected from the group consisting of aromatic amine in which aromatic ring has a side chain with a carbon atom number of 0˜30 and an amino number of 1˜5, or the mixture thereof. Preferred is diphenylamines, in which the aromatic ring has a side chain with a carbon atom number of 4˜20 and an amino number of 1˜4, alkylated diphenylamines and the mixture thereof. The most preferred is the alkylated diphenylamine in which the aromatic ring has a side chain with a carbon atom number of 4-8, the alkylated diphenylamine in which the aromatic ring has a side chain with a carbon atom number of 9-10, and the mixture thereof. Said amide is one selected from the group consisting of amide prepared by reacting a fatty acid having a carbon atom number between 1˜30, especially between 12˜18, with an organic amine having an amino number between 1˜5 and a carbon atom number between 1˜12 or aqua ammonia. Said amide is preferably one prepared by reacting a fatty acid having a carbon atom number between 1˜30, especially between 12˜18, with an organic amine having an amino number between 1˜5 and carbon atom number between 1˜12 in a molar ratio of 2:1˜1:2, wherein the organic amine is preferably one selected from the group consisting of diethanolamine, hydroxyethyl ethylene diamine, diethylene triamine, triethylene tetramine, tetraethylene pentamine, dipropylene triamine, tripropylene tetramine, tetrapropylene pentamine and the mixture thereof. The most preferred amide is one selected from the group consisting of stearyl amide obtained by reacting stearic acid with diethanolamine, stearyl amide obtained by reacting stearic acid with hydroxyethyl ethylene diamine, stearyl amide obtained by reacting stearic acid with diethylene triamine, stearyl amide obtained by reacting stearic acid with triethylene tetramine, oleic acid amide obtained by reacting oleic acid with diethanolamine, oleic acid amide obtained by reacting oleic acid with hydroxyethyl ethylene diamine, oleic acid amide obtained by reacting oleic acid with diethylene triamine, oleic acid amide obtained by reacting oleic acid with triethylene tetramine, palmityl amide obtained by reacting palmitic acid with diethanolamine, palmityl amide obtained by reacting palmitic acid with hydroxyethyl ethylene diamine, palmityl amide obtained by reacting palmitic acid with diethylene triamine, palmityl amide obtained by reacting palmitic acid with triethylene tetramine, myristyl amide obtained by reacting myristic acid with diethanolamine, myristyl amide obtained by reacting myristic acid with hydroxyethyl ethylene diamine, myristyl amide obtained by reacting myristic acid with diethylene triamine, myristyl amide obtained by reacting myristic acid with triethylene tetramine, lauryl amide obtained by reacting lauric acid with diethanolamine, lauryl amide obtained by reacting lauric acid with hydroxyethyl ethylene diamine, lauryl amide obtained by reacting lauric acid with diethylene triamine, lauryl amide obtained by reacting lauric acid with triethylene tetramine, caprylamide obtained by reacting capric acid with diethanolamine, octylamide obtained by reacting octanoic acid with hydroxyethyl ethylene diamine, and N,N-dimethyl formamide, and the mixture thereof.

Preferably, the organic molybdenum additive of the present invention is prepared through steps as follows:

The organic molybdenum additive product is prepared by reacting the aforementioned reactants a, b and c in a weight-ratio of 49˜99: 0.1˜25: 0˜50, preferably 50˜90: 0.1˜15: 0.1˜50, and most preferably 50˜90: 1˜15: 1˜30.

The additive prepared according to the present invention has an infrared characteristic absorption peak between 1600˜1610 cm-1, different from the reactant.

Solvent may be added or may not be added during the preparation of the organic molybdenum additive of the present invention. When a solvent is added, the selected solvent to be added includes toluene, xylene, gasoline, water and/or the mixture thereof. If a solvent is added, the solvent may be removed out in a mode commonly known for one skilled in the art, for example, under condition of atmospheric pressure or reduced pressure after end of the reaction.

Said reaction temperature is between 60˜160° C., preferably 100˜130° C.

Said reaction time is between 1˜10 hrs, preferably 2˜6 hrs.

Said reaction is preferably carried out in an inert gas atmosphere, more preferably under nitrogen gas atmosphere.

In the organic molybdenum additive prepared according to the process according to the present invention, molybdenum content is 0.1˜8.0% based on the total weight of said additive, preferably 2.0˜7.0%.

The present invention further provides a lubricating composition containing aforementioned organic molybdenum additive together with further lubricating base oil. Said base oil may be mineral oil, vegetable oil or synthetic oil. Wherein the synthetic oil is Fisch-Tropsch synthetic oil, poly α-olefin synthetic oil or esters oil.

Aforementioned compositions may also contain other lubricant additives, such as, one or more specifies selected from the group consisting of antioxidant, detergent agent, dispersant agent, antirusting agent, antiwear additive, viscosity index improver, freezing point depressant. The antioxidant may be one selected from the group consisting of 2,6-di-tert-butyl p-cresol, benzotriazole derivatives, thiadiazole derivatives; the detergent agent may be one selected from the group consisting of petroleum sulfonate, synthetic sulfonate, alkyl salicylate, naphthenate or alkylphenolate sulfide; the dispersant agent may be one selected from the group consisting of succinimide, hydrocarbyl amines, multi-hydroxy succinates, hydrocarbyl substituted Mannich bases or hydrocarbyl substituted triazoles ; the antirusting agent may be one selected from the group consisting of petroleum sulfonate, synthetic sulfonate, benzotriazole or alkyl imidazoline phosphate ; the antiwear additive may be one selected from the group consisting of dialkyl dithiophosphate/ester, dithiocarbamate/ester, thiadiazole, tritolylphosphate, terpene sulfide or sulfurized fat oil; the viscosity index improver may be one selected from the group consisting of polymethacrylate, polyisobutylene, ethylene-propene copolymer or styrene-isoprene polymer; the freezing point depressant may be one selected from the group consisting of alkyl naphthalene, polymethacrylate, poly α-olefin, polyethylene-co-fumarate or vinyl acetate-co-fumarate polymer.

As it is required, aforementioned composition may also contain other additive that may be used as lubricant additive.

The organic molybdenum additive according to the present invention has excellent properties of antiwear and antifriction.

Obviously, various modifications and variations may be made by persons of skill in the art without violating the key concept and scope of the present invention. The technical solutions from these modifications and variations are all within the scope of the present invention. Examples of the present invention are used only as an illustrating example, and the real scope and concept of the present invention are pointed out in claims of the present application.

Following examples are intended to illustrate further the process of the present invention.

### EXAMPLE 1

To a 250 ml four-neck flask equipped with a stirrer, a thermometer, a reflex condenser and a feeder, 1 g dibutylamine (chemical pure), 40 g F10A lubricant additive (manufactured by CIBA Corp, with main constituent of glyceride of 3,5-di-tert-butyl p-hydroxybenzene propionic acid) and 90 ml of toluene were added and the temperature was raised to 70˜80° C. under nitrogen gas atmosphere. An aqueous solution prepared from 6 g ammonium paramolybdate (chemical pure) and 20 ml distilled water was added in droplet and the resulting mixture was reacted under refluxing at 100° C. for 6 hrs. The organic molybdenum lubricant additive M-02 was obtained by evaporating out toluene and filtering slag off from the reacted mixture, wherein the molybdenum content was 3.04% based on the total weight of said organic molybdenum additive.

### EXAMPLE 2

To a 250 ml three-neck flask equipped with a stirrer and a thermometer, 40 g F10A lubricant additive, 15 g of coco trimethlylene diamine (industrial grade, Jiangsu Feixiang Corp.) were added and the temperature was raised to 70˜80° C. under nitrogen gas atmosphere. 6 g molybdenum trioxide (reagent in chemical pure) was added and then the resulting mixture was reacted at 120° C. for 6 hrs, with the water formed being removed. The organic molybdenum lubricant additive N-02 was obtained, wherein the molybdenum content was 6.92% based on the total weight of said organic molybdenum additive.

### EXAMPLE 3

To a 250 ml four-neck flask identical to that in Example 1, 35 g diglyceride of 3,5-di-tert-butyl p-hydroxybenzene propionic acid and oleic acid, which was synthesized according to U.S. Pat. No. 6,046,263, 80 ml toluene and 12 g N-oleyl di(trimethylene) triamine, (industrial grade, Jiangsu Feixiang Corp) were added and the temperature was raised to 70˜80° C. under nitrogen gas atmosphere, An aqueous solution prepared from 6 g ammonium paramolybdate (chemical pure) with 20 ml distilled water was added in droplet and the resulting rupture was reacted under refluxing at 110° C. for 3 hrs. The organic molybdenum lubricant additive N-03 was obtained by evaporating out toluene and not forming slag till the reaction was ended, wherein the molybdenum content was 6.42% based on the total weight of said organic molybdenum lubricant additive.

### EXAMPLE 4

To a 250 ml four-neck flask identical to that in Example 1, 40 g pentaerythritol diester of 3,5-di-tert-butyl p-hydroxybenzene propionic acid and oleic acid, which was synthesized according to U.S. Pat. No. 6,046,263, 80 ml toluene and 1 g diphenylamine having a side chain with a carbon atom number of 8 on aromatic ring were added and the temperature was raised to 70˜80° C. under nitrogen gas atmosphere. An aqueous solution prepared from 4 g ammonium molybdate (chemical pure) and 10 ml distilled water was added in droplet and the resulting mixture was reacted under refluxing at 120° C. for 2 hrs. The organic molybdenum lubricant additive M-05 of the present invention was obtained by evaporating out toluene and filtering slag off from the reacted mixture, wherein the molybdenum content was 1.03% based on the total weight of said organic molybdenum lubricant additive.

### EXAMPLE 5

To a 250 ml four-neck flask identical to that in Example 1, 75 g of F10A, 20 g of stearyl amide prepared by reacting stearic acid with triethylene tetramine in a molar ratio 1:1 were added and the temperature was raised to 70˜80° C. under nitrogen gas atmosphere. An aqueous solution prepared from adding 9.3 g ammonium paramolybdate with 20 ml distilled water was added in droplet and the resulting mixture was reacted at 130° C. for 4 hrs and no slag was formed till the reaction was ended. The organic molybdenum lubricant additive N-05 was obtained, wherein the molybdenum content was 5.41% based on the total weight of said organic molybdenum lubricant additive.

### EXAMPLE 6

To a 250 ml of the four-neck flask identical to that in Example 1, 40 g diglyceride of 3,5-di-tert-butyl p-hydroxybenzene propionic acid and oleic acid, which was synthesized according to U.S. Pat. No. 6,046,263, 10 g oleoyl amide obtained by reacting oleic acid with hydroxyethyl ethylene diamine in a molar ratio 1:1 were added and the temperature was raised to 70˜80° C. under nitrogen gas atmosphere. An aqueous solution prepared from 10 g ammonium molybdate and 20 ml distilled water was added in droplet and the resulting mixture was reacted at 110° C. for 4 hrs. The organic molybdenum additive M-07 was obtained by filtering slag off from the reacted mixture, wherein the molybdenum content was 5.35% based on the total weight of said organic molybdenum additive.

### EXAMPLE 7

To a 250 ml four-neck flask identical to that in Example 1, 80 g F10A, 10 g laury amide obtained by reacting lauric acid with diethanolamine in a molar ratio 2:1 were added, and the temperature was raised to 70˜80° C. under nitrogen gas atmosphere. The aqueous solution prepared from 10 g ammonium molybdate and 20 ml distilled water was added in droplet and the resulting mixture was reacted at 130° C. for 2 hrs. The organic molybdenum lubricant additive N-07 was obtained by filtering slag off from the reacted mixture, wherein the molybdenum content was 5.28% based on the total weight of said organic molybdenum lubricant additive.

### EXAMPLE 8

To a 250 ml four-neck flask identical to that in Example 1, 40 g diglyceride of 3,5-di-tert-butyl p-hydroxybenzene propionic acid and stearic acid, which was synthesized according to U.S. Pat. No. 6,046,263, and 10 g octylamide obtained by reacting octanoic acid with diethylene triamine in a molar ratio 1:2 were added and the temperature was raised to 70˜80° C. under nitrogen gas atmosphere. The aqueous solution prepared from 10 g ammonium molybdate and 20 ml distilled water was added in droplet and the resulting mixture was reacted at 110° C. for 4 hrs. The organic molybdenum lubricant additive N-08 was obtained by filtering slag off from the reacted mixture, wherein the molybdenum content was 5.09% based on the total weight of said organic molybdenum lubricant additive.

### EXAMPLE 9

To a 250 ml four-neck flask identical to that in Example 1, 40 g mono glyceride of 3-tert-butyl-5-methyl p-hydroxybenzene propionic acid, which was synthesized according to U.S. Pat. No. 6,046,263, 80 ml toluene and 10 g N,N-dimethyl formamide (a reagent in chemical pure) were added and the temperature was raised to 70˜80° C. under nitrogen gas atmosphere. An aqueous solution prepared from 5 g ammonium molybdate and 20 ml distilled water was added in droplet and the resulting mixture was reacted under refluxing at 120° C. for 4 hrs. The organic molybdenum lubricant M-01 was obtained by evaporating out toluene and filtering slag off from the reacted mixture, wherein the molybdenum content was 2.93% based on the total weight of said organic molybdenum lubricant additive.

### EXAMPLE 10

To a 250 ml four-neck flask identical to that in Example 1, 40 g diglyceride of 3,5-di-tert-butyl p-hydroxybenzene propionic acid and oleic acid, which was synthesized according to U.S. Pat. No. 6,046,263, 80 ml toluene, 10 g coco trimethylene diamine, 2 g N,N-dimethyl formamide were added and the temperature was raised to 70˜80° C. under nitrogen gas atmosphere. The aqueous solution prepared from 6 g ammonium molybdate and 20 ml distilled water was added in droplet and the resulting mixture was reacted under refluxing at 150° C. for 2 hrs. The organic molybdenum lubricant additive N-10 was obtained by evaporating out toluene and filtering slag off from the reacted mixture, wherein the molybdenum content was of 5.53% based on the total weight of said organic molybdenum lubricant additive.

### EXAMPLE 11

To a 250 ml four-neck flask identical to that in Example 1, 6 g ammonium molybdate and 80 g distilled water were added, then 40 g F10A lubricant additive (manufactured by CIBA Corp, with main constituent of glyceride of 3,5-di-tert-butyl p-hydroxybenzene propionic acid) and 5 g N,N-dimethyl formamide were added, and the resulting mixture was reacted under refluxing under nitrogen gas atmosphere at 100° C. for 6 hrs. After the reaction was ended, the resultant product was deposited for layering to remove water phase. The organic molybdenum additive M-03 was obtained by evaporating out moisture remained in the oil phase and filtering slag off from the reacted mixture, wherein the molybdenum content was 2.67% based on the total weight of said organic molybdenum additive.

### EXAMPLE 12

To a 250 ml four-neck flask identical to that in Example 1, 40 g diglyceride of 3,5-di-teit-butyl p-hydroxybenzene propionic acid and oleic acid, which was synthesized according to U.S. Pat. No. 6,046,263, 80 ml toluene, 10 g N,N-dimethyl formamide and 2 g dibutylamine were added and the temperature was raised to 70˜80° C. under nitrogen gas atmosphere. An aqueous solution prepared from 8 g ammonium molybdate and 20 ml distilled water was added in droplet and the resulting mixture was reacted under refluxing at 110° C. for 2 hrs, The organic molybdenum additive M-04 was obtained by evaporating out toluene and filtering slag off from the reacted mixture, wherein the molybdenum content was 3.17% based on the total weight of said organic molybdenum additive.

### EXAMPLE 13

To a 250 ml four-neck flask identical to that in Example 1, 40 g F10A lubricant additive and 80 ml toluene were added and the temperature was raised to 70˜80° C. under nitrogen gas atmosphere. 3 g molybdenum trioxide was added and the resulting mixture was reacted under refluxing at 120° C. for 2 hrs. The organic molybdenum additive M-06 was obtained by evaporating out toluene and filtering slag off from the reacted mixture, wherein the molybdenum content was 0.24% based on the total weight of said organic molybdenum additive.

### EXAMPLE 14

To a 250 ml four-neck flask identical to that in Example 1, 25 g diglyceride of 3,5-di-tert-butyl p-hydroxybenzene propionic acid and oleic acid, which was synthesized according to U.S. Pat. No. 6,046,263, 80 ml toluene, 20 g N,N-dimethyl formamide and 2 g dibutylamine were added and the temperature was raised to 70˜80° C. under nitrogen gas atmosphere. The aqueous solution prepared from 6 g ammonium molybdate and 20 ml distilled water was added in droplet and the resulting mixture was reacted under refluxing at 110° C. for 3 hrs. The organic molybdenum additive M-08 was obtained by evaporating out toluene and no slag was formed during the reaction process, wherein the molybdenum content was 6.42% based on the total weight of said organic molybdenum lubricant additive.

### EXAMPLE 15

To a 250 ml foul neck flask identical to that in Example 1, 20 g diglyceride of 3,5-di-tert-butyl p-hydroxybenzene propionic acid and stearic acid, which was synthesized according to U.S. Pat. No. 6,046,263, and 80 ml toluene and 15 g lauryl amide obtained by reacting lauric acid with diethanolamine in a molar ratio of 1:1 and 2 g dibutylamine were added and the temperature was raised to 70˜80° C. under nitrogen gas atmosphere. The aqueous solution prepared from 10 g ammonium molybdate and 20 ml distilled water was added in droplet and the resulting mixture was reacted under refluxing at 130° C. for 4 hrs. The organic molybdenum additive M-09 was obtained by evaporating out toluene and filtering slag off from the reacted mixture, wherein the molybdenum content was 5.66% based on the total weight of said organic molybdenum additive.

### EXAMPLE 16

Aforementioned organic molybdenum lubricant additives M-01, M-02, M-04 and M-08, and the additives used as control, i.e. F10A lubricant additive (manufactured by CIBA Corp), Van 855 lubricant additive (manufactured by VANDERBILT Corp, with an actually measured molybdenum content of 6.62%), and a composition compounded of F10A lubricant additive and Van 855 lubricant additive in an equal-weight ratio were added respectively into a 150SN base oil (I kind of oil) with the same dose according to the same formulation (ratio) as that of normal lubricant complex additive. Each of the organic molybdenum additives of the present invention and the control additives was added in the same quantity of 0.5%, and each of compounded lubrication systems was further added with 4.5% of SF gasoline engine oil as a composite agent (manufactured by Wuxi Southern Additive Corp.) respectively. Antiwear and antifriction property of each compounded system obtained was measured respectively by using a four-ball apparatus for assessing test of the antiwear and antifriction property (Industry Standard SH/T 0189-92). Test conditions were: a temperature of 75° C., a rotation rate of 1200 rpm, a load of 40 kg, and a testing time of 1 hr. Results are recorded in Table 1. The data given by the test with the four-ball apparatus for measuring antiwear and antifriction include friction coefficient and abraded spot diameter. The lower the abraded spot diameter and friction coefficient, the more excellent effect of antiwear and antifriction is.

TABLE 1
Testing results with four-ball apparatus for antiwear and
antifriction property of the synthesized organic molybdenum and
the compounded system in the Comparative Example

Result

| | Abraded | |
|---|---|---|
| | spot diameter | Friction |
| No. | (mm) | coefficient |
| F10A | 0.55 | 0.105 |
| Van 855 | 0.48 | 0.091 |
| F10A + Van 855 | 0.70 | 0.085 |
| M-01 | 0.44 | 0.068 |
| M-02 | 0.44 | 0.065 |
| M-04 | 0.45 | 0.070 |
| M-08 | 0.42 | 0.060 |

It can be seen from the results shown in Table 1 that the compounded systems containing the organic molybdenum additive of the present invention have less friction coefficientss and less abraded spot diameters than the systems of Comparative Examples, showing that the organic molybdenum lubricant additives according to the present invention are superior to the prior additives in terms of the properties of antiwear and antifriction.

### EXAMPLE 17

The properties of antiwear and antifriction for each compounded lubrication system said below were measured according to the method as follows. Said method comprises using a SRV high frequency linear vibration tester to measure the properties of antiwear and antifriction under test conditions: a temperature of 80, a load of 300N, a testing time of 1 hr, a stroke of 1 mm and a frequency of 50 Hz. Friction pairs are in sphere contacting. Test results are given in friction coefficient and abraded spot diameter. The lower the value of the abraded spot diameter and friction coefficient, the more excellent result of correspondent antiwear and antifriction property is.

1. The compounded lubrication system was prepared as follows: hydrogenated base oils (100N and 150N hydrogenated base oil were blended in a weight-ratio of 2:3) was added respectively with 0.67% (as calculated according to the total weight of said compounded lubrication system) of aforementioned organic molybdenum additive M-02, N-03, M-057 M-07 and additives used as control including: lubricant additive F10A (manufactured by CIBA Corp.), Van 855 lubricant additive (manufactured by VANDERBILT Corp. with 6.62% of molybdenum content that was measured really), F10A compounded with Van 855 in an equal-weight ratio. Each of mixtures obtained above was added with 3% (as calculated on the total weight of said compounded lubrication system) of succinimide dispersant agent 152 (manufactured by Wuxi Southern Additive Corp), 0.5% (as calculated on the total weight of said compounded lubrication system) of 7169 (zinc dialkyl dithiophosphate, manufactured by Ethyl Corp), 0.3% (as calculated on the total weight of said compounded lubrication system) of L67 antioxidant (manufactured by CIBA Corp) and 2% (as calculated on the total weight of said compounded lubrication system) of alkyl benzene calcium sulfonate detergent agent 106 (manufactured by Wuxi Southern Additive Corp), each compounded lubrication system was obtained.

Table 2 shows SRV results measured by using the above method for each compounded lubrication system obtained in aforementioned 1.

TABLE 2
SRV results of the antiwear and antifriction property
by testing in hydrogenated base oil

Result

| | Abraded spot diameter | |
|---|---|---|
| Additive | (mm) | Friction coefficient |
| F10 | 0.57 | 0.125 |
| 855 | 0.53 | 0.100 |
| F10A + 855 | 0.57 | 0.115 |
| M-02 | 0.52 | 0.090 |
| N-03 | 0.48 | 0.085 |
| M-05 | 0.53 | 0.098 |
| M-07 | 0.50 | 0.087 |

2. The compounded lubrication systems were prepared according to following method: Fisch-Tropsch lubricants (the viscosity at 100° C. was 5.89 centipoises) was added respectively with 0.5% (as calculated according to total weight of said compounded lubrication system) of aforementioned organic molybdenum additive M-02, N-03, M-05, M-07 and additives used as control, e.g. F10A lubricant additive (manufactured by CIBA Corp.), Van 866 (manufactured by VANDERBILT Corp, the molybdenum content measured was 6.62%), F10A compounded with Van 855 in an equal-weight ratio. Each of the mixtures obtained above was further added with 2% of succinimide dispersant agent 151 (manufactured by Wuxi Southern Additive Corp), 0.6% of 202 (zinc dialkyl dithiophosphate, manufactured by Liaoning Tianhe Fine Chemical Corporation) and 0.5% of L57 antioxidant (manufactured by CIBA Corp.) and 0.5% of alkyl benzene calcium sulfonate detergent agent 106 (manufactured by Wuxi Southern Additive Corp), each of the compounded lubrication system was obtained.

Table 3 shows SRV test results measured by the above method for each compounded lubrication system prepared in aforementioned 2.

TABLE 3
SRV test results of antiwear and antifriction property
by testing in Fisch-Tropsch synthetic lubricant oil

result

| | Abraded spot diameter | |
|---|---|---|
| Additive | (mm) | Friction coefficient |
| F10 | 0.51 | 0.116 |
| 855 | 0.50 | 0.093 |
| F10A + 855 | 0.50 | 0.102 |
| M-02 | 0.48 | 0.087 |
| N-03 | 0.45 | 0.083 |
| M-05 | 0.49 | 0.092 |
| M-07 | 0.46 | 0.084 |

It can be seen from test results shown in Table 2 and Table 3 that in different lubricant oils or different additive formulation systems, the compounded systems containing the organic molybdenum additive of the present invention have less friction coefficients and abraded spot diameters than those of Comparative Examples, showing that the organic molybdenum additives according to the present invention have a superior antiwear and antifriction property than those in the prior art.

1. An organic molybdenum additive, said additive is prepared by reacting materials as follows:
a. polylol ester of p-hydroxybenzene alkyl acid,
b. an inorganic molybdenum compound, and
c. an aliphatic amine, an aromatic amine, an amide, or the mixture thereof.

2. The organic molybdenum additive according to claim 1, in which said polylol ester of p-hydroxybenzene alkyl acid has an alcohol with a carbon atom number between 2-12 and a hydroxyl number between 2˜5.

3. The organic molybdenum additive according to claim 2, in which said polylol ester of p-hydroxybenzene alkyl acid has a general formula as follows: 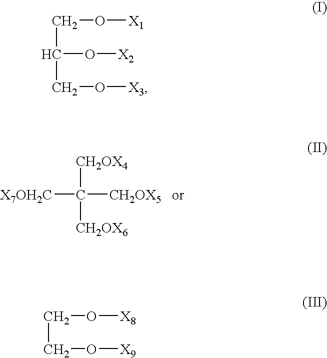
wherein at least one of X₁, X₂ and X₃ is a group of structural formula (a), at least one of X₄, X₅, X₆ and X₇ is a group of structural formula (a), at least one of X₈ and X₉ is a group of structural formula (a), the remaining groups may be the same or different and are independently selected from the group consisting of H atom, the group of structural formula (a) and the group of structural formula (b); 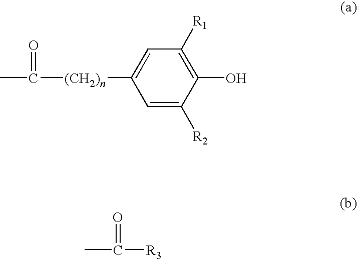
Wherein R₁ and R₂ may be the same or different, and are independently selected from alkyl having a carbon atom number between 1˜4 ; n is an integer number of 2˜12; R₃ is H or a saturated or unsaturated hydrocarbyl group having carbon number between 1˜30.

4. The organic molybdenum additive according to claim 3, in which n is an integer number of 2˜8, R₃ is a saturated or unsaturated hydrocarbyl group having a carbon atom number between 5-20.

5. The organic molybdenum additive according to claim 4, in which both R₁ and R₂ are tert-butyl, n is 2, 3 or 4, and R₃ is a saturated or unsaturated hydrocarbyl group having a carbon atom number between 10-18.

6. The organic molybdenum additive according to claim 2, in which said polylol ester of p-hydroxybenzene alkyl acid is one selected from the group consisting of: monoglyceride of 3,5-di-tert-butyl p-hydroxybenzene propionic acid, diglyceride of 3,5-di-tert-butyl p-hydroxybenzene propionic acid, triglyceride of 3,5-di-tert-butyl p-hydroxybenzene propionic acid, monopentaerythritol ester of 3,5-di-tert-butyl p-hydroxybenzene propionic acid, pentaerythritol diester of 3,5-di-tert-butyl p-hydroxybenzene propionic acid, pentaerythritol triester of 3,5-tert-butyl p-hydroxybenzene propionic acid, pentaerythritol tetraester of 3,5-di-tert-butyl p-hydroxybenzene propionic acid, monoglycol ester of 3,5-di-tert-butyl p-hydroxybenzene propionic acid, ethylene glycol diester of 3,5-di-tert-butyl p-hydroxybenzene propionic acid (a compound of structural formula III, wherein, both X₈ and X₉ are groups selected from group represented by structural formula (a) in which n is 2 and both R₁ and R₂ are tert-butyl), diglyceride of 3,5-di-tert-butyl p-hydroxybenzene propionic acid and oleic acid, diglyceride of 3,5-di-tert-butyl p-hydroxybenzene propionic acid and stearic acid, diglyceride of 3,5-di-tert-butyl p-hydroxybenzene propionic acid and lauric acid, diglyceride of 3,5-di-tert-butyl p-hydroxybenzene propionic acid and myristic acid, diglyceride of lauric acid, diglyceride of 3,5-di-tert-butyl p-hydroxybenzene propionic acid and palmitic acid, triglyceride of 3,5-di-tert-butyl p-hydroxybenzene propionic acid, oleic acid and stearic acid, triglyceride of 3,5-di-tert-butyl p-hydroxybenzene propionic acid and distearic acids, triglyceride of 3,5-di-tert-butyl p-hydroxybenzene propionic acid and dilauric acids, triglyceride of 3,5-di-tert-butyl p-hydroxybenzene propionic acid and dipalmitic acids, triglyceride of 3,5-di-tert-butyl p-hydroxybenzene propionic acid, lauric acid and stearic acid, triglyceride of 3,5-di-tert-butyl p-hydroxybenzene propionic acid, palmitic acid and stearic acid, triglyceride of 3,5-di-tert-butyl p-hydroxybenzene propionic acid, myristic acid and stearic acid, pentaerythritol diester of 3,5-di-tert-butyl p-hydroxybenzene propionic acid and oleic acid, pentaerythritol diester of 3,5-di-tert-butyl p-hydroxybenzene propionic acid and stearic acid, pentaerythritol diester of 3,5-di-tert-butyl p-hydroxybenzene propionic acid and lauric acid, pentaerythritol diester of 3,5-di-tert-butyl p-hydroxybenzene propionic acid and myristic acid, pentaerythritol diester of 3,5-di-tert-butyl p-hydroxybenzene propionic acid and palmitic acid, pentaerythritol triester of 3,5-di-tert-butyl p-hydroxybenzene propionic acid, lauric acid and stearic acid, pentaerythritol triester of 3,5-di-tert-butyl p-hydroxybenzene propionic acid, oleic acid and stearic acid, pentaerythritol triester of 3,5-di-tert-butyl p-hydroxybenzene propionic acid and palmitic acid and stearic acid, pentaerythritol triester of 3,5-di-teit-butyl p-hydroxybenzene propionic acid and distearic acids, pentaerythritol tetraester of 3,5-di-tert-butyl p-hydroxybenzene propionic acid, oleic acid and distearic acids, glycol ester of 3,5-di-tert-butyl p-hydroxybenzene propionic acid and stearic acid, and die mixture thereof.

7. The organic molybdenum additive according to claim 1, in which said inorganic molybdenum compound is one selected from the group consisting of ammonium molybdate, ammonium paramolybdate, sodium molybdate, molybdenum trioxide, and the mixture thereof.

8. The organic molybdenum additive according to claim 1, in which said aliphatic amine is one selected from the group consisting of primary, secondary, tertiary amine or alkylene diamine having a carbon atom number from 4 to 30 and amino number between 1˜5,, and the mixture thereof; said aromatic amine is one selected from the group consisting of aromatic amine in which aromatic ring has a side chain with a carbon atom number of 0˜30 and an amino number of 1˜5, and the mixture thereof; said amide is one selected from the amide obtained by reacting a fatty acid having a carbon atom number between 1˜30 with an organic amine having an amino number between 1˜5 and a carbon atom number between 1˜12 or aqua ammonia.

9. The organic molybdenum additive according to claim 8, in which said aliphatic amine is one selected from the group consisting of primary, secondary and tertiary amines having a carbon atom number between 4˜25 and an amino number between 1˜4, and mono-alkylated alkylene diamine derived from a fatty acid with a carbon atom number of 12˜18, and the mixture thereof; said aromatic amine is one selected from the group consisting of diphenylamine, alkylated diphenylamine, in which the aromatic ring has a side chain with a carbon atom number of 4˜20 and an amino number between 1˜4, and the mixture thereof; said amide is one selected from the group consisting of amide obtained by reacting a fatty acid having a carbon atom number between 12˜18 with an organic amine having an amino number between 1˜5 and a carbon atom number between 1˜12.

10. The organic molybdenum additive according to claim 8, in which said aliphatic amine is one selected from the group consisting of butyl amine, hexyl amine, octyl amine, lauryl amine, cetyl amine, stearyl amine, dibutyl amine, diamyl amine, dihexyl amine, dodecyl ethylene diamine, dodecyl trimethylene diamine, hexadecyl ethylene diamine, hexadecyl trimethylene diamine, octadecyl ethylene diamine, octodecyl trimethylene diamine, coco trimethylene diamine, tallow trimethylene diamine, oleyl trimethylene diamine, N,N-dimethyl lauryl amine, N,N-dimethyl cetyl amine, N,N-dimethyl stearyl amine, and the mixture thereof; said aromatic amine is one selected from the group consisting of an alkylated diphenylamine in which the aromatic ring has a side chain with a carbon atom number of 4-8 and an alkylated diphenylamine in which aromatic ring has a side chain with a carbon atom number of 9-10, and the mixture thereof; said amide is one selected from the group consisting of amide prepared by reacting a fatty acid having a carbon atom between 12˜18 with an organic amine selected from diethanolamine, hydroxyethyl ethylene diamine, diethylene triamine, triethylene tetramine, tetraethylene pentamine, dipropylene triamine, tripropylene tetramine, tetrapropylene pentamine and the mixture thereof in a ratio of 2:1˜1:2.

11. The organic molybdenum additive according to claim 8, in which said amide is one selected from the group consisting of stearyl amide obtained by reacting stearic acid with diethanolamine, stearyl amide obtained by reacting stearic acid with hydroxyetlhyl ethylene diamine, stearyl amide obtained by reacting stearic acid with diethylene triamine, stearyl amide obtained by reacting stearic acid with tretethylene tetramine, oleic acid amide obtained by reacting oleic acid with diethanolamine, oleic acid amide obtained by reacting oleic acid with hydroxyethyl ethylene diamine, oleic acid amide obtained by oleic acid with diethylene triamine, oleic acid amide obtained by reacting oleic acid with triethylene tetramine, palmityl amide obtained by reacting palmitic acid with diethanolamine, palmityl amide obtained by reacting palmitic acid with hydroxyethyl ethylene diamine, palmityl amide obtained by reacting palmitic acid with diethylene triamine, palmityl amide obtained by reacting palmitic acid with triethylene tetramine, myristic acid amide obtained by reacting myristic acid with diethanolamine, myristyl amide obtained by reacting myristic acid with hydroxyethyl ethylene diamine, myristyl amide obtained by reacting myristic acid with diethylene triamine, myristyl amide obtained by reacting myristic acid with triethylene tetramine, lauryl amide obtained by reacting lauric acid with diethanolamine, lauryl amide obtained by reacting lauric acid with hydroxyethyl ethylene diamine, lauryl amide obtained by reacting lauric acid with diethylene triamine, lauryl amide obtained by reacting lauric acid with triethylene tetramine, capryl amide obtained by capric acid with diethanolamine, octyl amide obtained by reacting octanoic acid with hydroxyethyl ethylene diamine, and N,N-dimethyl formamide, and the mixture thereof.

12. The organic molybdenum additive according to claim 1, in which the weight-ratio of reactant a, b and c is 49˜99: 0.1˜25: 0˜50.

13. The organic molybdenum additive according to claim 12, in which the weight-ratio of reactant a, b and c is 50˜90: 0.1˜15: 0.1˜50.

14. The organic molybdenum additive according to claim 12, in which the weight-ratio of reactants a, b and c is 50˜90: 1˜15: 1˜30.

15. The organic molybdenum additive according to claim 1, in which the molybdenum content of the additive obtained is 0.1˜8.0% based on the total weight of said additive.

16. The organic molybdenum additive according to claim 10, in which the molybdenum content of the additive obtained is 2.0˜7.0%.

17. The organic molybdenum additive according to claim 1, in winch said additive has an infrared characteristic absorption peak at 1600˜1610 cm⁻¹ different from those of reactants.

18. A preparation method of the organic molybdenum additive, comprising reacting the following materials:
a. polylol ester of p-hydroxybenzene alkyl acid,
b. an inorganic molybdenum compound, and
c. an aliphatic amine, an aromatic amine, a mixed amine, an amide, or the mixture thereof.

19. The preparation method according to claim 18, in which a solvent selected from the group consisting of toluene, xylene, gasoline, water, and the mixture thereof may be used during the reaction.

20. The preparation method according to claim 18, in which the reaction temperature is 60˜160° C. and the reaction time is 1˜10 hrs.

21. The preparation method according to claim 20, in which the reaction temperature is 100˜130° C. and the reaction time is 2˜6 hrs.

22. The preparation method according to claim 18, in which said reaction is carried out under an inert-gas atmosphere.

23. The preparation method according to claim 22, in which said inert gas is nitrogen gas.

24. A lubricant composition comprising an organic molybdenum additive according to claim 1.

25. The lubricant composition according to claim 24, in which said composition further contains lubricating base oil selected from mineral oils, vegetable oils or synthetic oils.

26. The lubricant composition according to claim 25, in which said synthetic oil is Fisch-Tropsch oil, polyα-olefin synthetic oils or ester oils.

27. The lubricant composition according to claim 24, in which said composition further contains one or more other lubricant additives selected from antioxidant, detergent agent, dispersant agent, antitrusting agent, antiwear additive, viscosity index improver and freezing point depressant.

28. The lubricant composition according to claim 27, in which, the antioxidant may be one selected from the group consisting of 2,6-di-tert-butyl p-cresol, benzotriazole derivative or thiadiazole derivative ; the detergent agent may be one selected from the group consisting of petroleum sulfonate, synthetic sulfonate, alkyl salicylate, naphthenate or alkyl-phenolate sulfide the dispersant agent may be one selected from the group consisting of succinimide, hydrocarbyl amine, multi-hydroxy succinate, hydrocarbyl substituted Mannich base or hydrocarbyl substituted triazole ; the antirusting agent may be one selected from the group consisting of petroleum sulfonate, synthetic sulfonate, benzotriazole or alkyl imidazoline phosphate ; the antiwear additive may be one selected from the group consisting of dialkyl dithiophosphate(/ester), dithiocarbamate(/ester), thiadiazole, tritolyl phosphate, terpene sulfide or sulfurized fat oil; the viscosity index improver may be one selected from the group consisting of polymethacrylate, polyisobutylene, ethylene-propylene copolymer or styrene-isoprene polymer; the freezing point depressant may be one selected from the group consisting of alkyl naphthalene, polymethacrylate, polyα-olefine, polyethylene-fumaric acid copolymer or vinyl acetate-fumarate copolymer.

29. Use of the organic molybdenum additive according to claim 1 in engine lubricating oil, gear oil, hydraulic oil or oils for metal working, and lubricant grease as a lubrication effective constituent.

30. The use according to claim 29, in which said lubrication improves the properties of antiwear and/or antifriction of said oils and lubricant grease.
